(19) United States
(12) Patent Application Publication
(10) Pub. No.: US 2025/0182091 A1
(43) Pub. Date: Jun. 5, 2025

(54) METHOD AND SYSTEM FOR VALIDATION OF CORRECT EXECUTION OF WORKFLOW

(71) Applicant: Fireblocks Ltd., Tel Aviv (IL)

(72) Inventors: Arik GALANSKY, Tel Aviv (IL); Roman DVORKIN, Givatayim (IL); Oren YOMTOV, Tel Aviv (IL)

(73) Assignee: Fireblocks Ltd., Tel Aviv (IL)

(21) Appl. No.: 18/524,917

(22) Filed: Nov. 30, 2023

(51) Int. Cl. G06Q 20/36; H04L 9/08; H04L 9/30

(52) U.S. Cl. CPC G06Q 20/3674; H04L 9/088; H04L 9/30

(57) ABSTRACT

A system for validation of a correct execution of an authorization workflow including a processor of an orchestrator node connected to an at least one client entity node, a verifier entity node and to a plurality of approvers' entity nodes and a memory on which are stored machine-readable instructions that when executed by the processor, cause the processor to: receive, from the at least one client entity node, a blockchain transaction (Tx) execution request comprising the authorization workflow definition; provide the Tx execution request to the verifier entity node configured to execute the authorization workflow; receive a proof of the authorization workflow execution according to the workflow definition from the verifier entity node; provide the proof of the authorization workflow execution to the plurality of approvers' entity nodes; and collect approvals from the plurality of approvers' entity nodes to allow for an execution of the Tx.

### TECHNICAL FIELD

The present disclosure relates generally to blockchain transactions and, more specifically, to the validation of the correct execution of workflow before the execution of a blockchain transaction.

### BACKGROUND

A typical “crypto wallet” is controlled by a private key and represented by a public key. An organization or an owner of a crypto wallet that controls a blockchain-related address holds private keys (or private key shares) that relate to that address on the blockchain and can sign transactions to execute on that address. A way to secure the crypto wallet and protect the funds in the wallet is to restrict the ability to execute different transactions based on an authorization workflow.

The authorization workflow (or policy) is a set of codified rules that may determine if a transaction should be executed, not executed at all or only executed upon being approved by a preconfigured sequence of approvers. The decision regarding which approval is required may depend on a variety of factors, such as, for example, amount transferred, source account, destination account, asset type, action type, configuration of the account, etc. Multiple approvers might be required in the process (with possibly a defined order). The execution of a transaction might be implemented as a signature, blockchain broadcasting, smart contract calls, or other means that put the transaction in effect in the system.

In a typical system that uses an authorization workflow before executing a transaction, an orchestrator entity needs to run the logic of the workflow, determine the relevant approvals required, orchestrate the process to gain these approvals, and eventually activate or allow the execution of the transaction only when all the correct approvals have been obtained. This conventional approach has several shortcomings. The current design of the orchestrators is trusted, and the execution of a transaction assumes by default that it was designed, deployed, and run properly. Alternatively, the workflow may be public and expose the entire process and other information about it, including participants.

Accordingly, an efficient method and system for validation of correct execution of workflow prior to execution of a blockchain transaction are desired.

### SUMMARY

A system of one or more computers can be configured to perform particular operations or actions by virtue of having software, firmware, hardware, or a combination of them installed on the system that, in operation causes or cause the system to perform the actions. One or more computer programs can be configured to perform particular operations or actions by virtue of including instructions that, when executed by data processing apparatus, cause the apparatus to perform the actions.

In one general aspect, a system for validation of a correct execution of an authorization workflow may include a processor of an orchestrator node connected to an at least one client entity node, a verifier entity node and to a plurality of approvers' entity nodes and a memory on which are stored machine-readable instructions that when executed by the processor, cause the processor to: receive, from the at least one client entity node, a blockchain transaction (Tx) execution request comprising the authorization workflow definition; provide the Tx execution request to the verifier entity node configured to execute the authorization workflow; receive a proof of the authorization workflow execution according to the workflow definition from the verifier entity node; provide the proof of the authorization workflow execution to the plurality of approvers' entity nodes; and collect approvals from the plurality of approvers' entity nodes to allow for an execution of the Tx.

In one general aspect, method may include receiving, from the at least one client entity node, a blockchain transaction (Tx) execution request comprising the authorization workflow definition; providing the Tx execution request to the verifier entity node configured to execute the authorization workflow; receiving a proof of the authorization workflow execution according to the workflow definition from the verifier entity node; providing the proof of the authorization workflow execution to the plurality of approvers' entity nodes; and collecting approvals from the plurality of approvers' entity nodes to allow for an execution of the Tx.

In one general aspect, non-transitory computer-readable medium may include receiving a blockchain transaction (Tx) execution request comprising the authorization workflow definition; providing the Tx execution request to the verifier entity node configured to execute the authorization workflow; receiving a proof of the authorization workflow execution according to the workflow definition from the verifier entity node; providing the proof of the authorization workflow execution to the plurality of approvers' entity nodes; and collecting approvals from the plurality of approvers' entity nodes to allow for an execution of the Tx.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram explaining an environment for validation of the correct execution of workflow prior to execution of a blockchain transaction consistent with the disclosed embodiments.

FIG. 2 is an example flowchart of a method for validation of correct execution of workflow prior to execution of a blockchain transaction consistent with the disclosed embodiments.

FIG. 3 is a further example flowchart of a method for validation of correct execution of workflow prior to execution of a blockchain transaction consistent with the disclosed embodiments.

FIG. 4 is a schematic diagram of a hardware layer of a node according to the disclosed embodiments.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

According to the disclosed embodiments, a novel method for validation of correct execution of workflow prior to the execution of a blockchain transaction, is provided.

In one embodiment, a method for validation of correct execution of workflow prior to execution of a blockchain transaction is executed in a way that makes the orchestrator trustless. The orchestrator is a trustless actor that can provide proof that the approval flow has been executed correctly and all proper approvals have been provided so that any sequential actor in the process can easily validate this claim and act with the assurance that the flow was correctly and properly completed.

According to the disclosed embodiments, a wallet owner may define an authorization workflow. In some embodiments, other entities (actors) may set the workflow. For example, a wallet provider may set policies for its users.

The workflow includes the rules for when a blockchain transaction is allowed to execute and if any approvals are required to approve the execution of the transaction given some specific conditions. The transaction execution conditions, order of validation of the conditions, and other requirements may be included in the workflow.

In one embodiment, the approval flow may be validated (i.e., proven) with a Zero-knowledge proof (ZKP). The approval flow may have some parameters to be validated. For example, the approval flow may require knowing about the amount of crypto assets that have been transferred in the last 24 hours, because the policy only allows up to 100 (or another set number) crypto units in a day. The disclosed system may verify these parameters (wallet account restrictions) as well. The verification process may use the ZKP or other cryptographic and non-cryptographic mechanisms.

Once the workflow is put into action, from that point forward, any transaction on that wallet is required to comply with the workflow until a new workflow is applied. Changing the workflow might require some authorization flow as well. The agreed-upon workflow or commitment of a workflow (when the workflow is private/secret) is distributed in some form to all relevant parties or made public. This can be done by saving some sort of a hash or other schematic description.

Once a new transaction (or another action that is supposed to act on behalf of the wallet) is entered into the system by a privileged user, that transaction goes through a workflow verification process. The verification process may be run by an orchestrator, which determines if the transaction is allowed according to the policy and which approvals are required for execution based on policy parameters.

The orchestrator may collect proper approvals in the form of cryptographic signatures by the relevant approvers. Approvers might be presented with partial proof of the policy to show that their signature is required. Once all approvals are collected, the orchestrator, or someone on his behalf, creates proof of correct execution that the policy was run according to the latest predefined policy that the wallet is committed to. The proof is accompanied by or includes all the approvals as required by the workflow. If proper proof cannot be provided, the next steps are not executed, and signature (or Tx) is aborted.

In one disclosed embodiment, the systems that need to sign, execute, or monitor the transactions in the wallet can verify the proof against the transaction and the initial commitment of the policy. The verification provides them with knowledge that the transaction and the approvals fulfill the workflow requirements and are allowed, according to the workflow, to be signed, transmitted, or executed on the blockchain.

Any party that wants to verify the validity of the execution and has the workflow information (i.e., workflow or commitment), approvals, and transaction information can make sure that the account runs by the workflow defined.

The disclosed process is relevant for the setup of a wallet provider and a client, and also for the setup of a wallet provider with a client and clients of the client, etc.

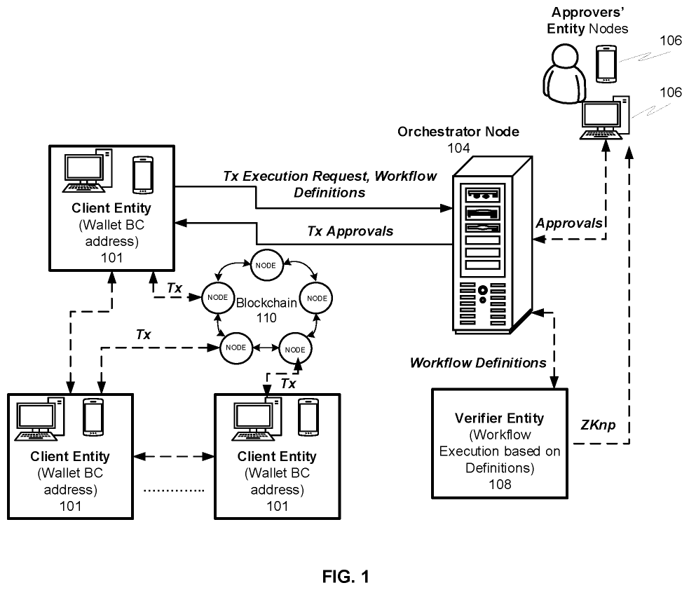

FIG. 1 illustrates a schematic diagram explaining an environment for validation of the correct execution of workflow prior to execution of a blockchain transaction consistent with the disclosed embodiments.

Referring to FIG. 1, client entities 101 own crypto wallets having an address on the blockchain 110 that is protected by a private key whether it is an account, a smart contract, or any other entity. The same applies for blockchain 110 addresses that are protected by multiple keys (multi-sig) or any other combination of keys and key shares (MPC, etc.). Note that the transactions (Tx) may come from different sources—as long as the Tx passes the validation it is considered valid. There might be a situation where a settlement partner for example creates the transaction, but still user's wallet needs to sign the Tx to execute it.

Transactions (Tx) represent the action that acts on behalf of the wallets owned by client entities 101. The Tx can represent a blockchain 110 transaction, a smart contract call, or any sort of message signed by the wallet private key that could later be used for any sort of action associated with the wallets.

Each possible Tx is associated with a pre-defined workflow. The workflow represents a set of rules that define some controls over the ability or permission to execute a Tx. The rules may have some interdependency between them. The recluse may be implemented as a configuration, a standard, or any sort of result of code execution. The rules can define conditions for when a given Tx can be executed, by who the Tx can be initiated, executed, or approved, and what forms of process the Tx needs to go through in order to be considered approved.

In one embodiment, the approval workflow may be validated (i.e., proven) with a Zero-knowledge proof (ZKP). The approval flow may have some parameters to be validated. For example, the approval flow may require knowing about the amount of crypto assets that have been transferred over a pre-set time period, because the wallet policy only allows up to a certain amount of crypto assets to be transferred over this time period. The disclosed system may verify these parameters (wallet account restrictions) as well. The verification process may use the ZKP or other cryptographic and non-cryptographic mechanisms.

An orchestrator 104 is a system, a server, or any other facilitator(s) that runs the process to validate workflows and transactions (Tx). The orchestrator 104 is supposed to be trustless, according to the disclosed embodiments. The orchestrator 104 can be a single entity configured to perform all of the relevant steps or a collection of entities (not shown), taking partial ownership of the process, for example, separating a proof creator from the orchestrator. The trustless orchestrator 104 is a trustless actor that is not supposed to be trusted by others, to be honest. A trustless actor cannot cheat the other participants and cause harm or any breaking in the system. The trustless actor can be replaced by others performing the same actions because their role in the system is strictly functional rather than personal.

According to the disclosed embodiments, approvals of the Tx are required prior to the execution on the blockchain 110. The Tx needs to be approved by some people or organizations or computer systems/nodes. The approval can be provided in many different non-limiting means, including a cryptographic signature on some agreed-upon content. Approvers' entities 106 can approve the Tx based on the workflow definitions, transaction information, or any other consideration, including blockchain 110 or real-world related information that is outside of the realm of the transaction itself.

A verifier entity 108 is an actor that makes sure, for any reason, that transactions (Tx) are executed according to the predefined workflow. The approver(s) 106 may hold the commitment of the workflow and can verify it before, during, or after the execution process, separately, or in bulk as part of an auditing process of any kind. A continuous process may be implemented to allow for validation not to become stale as time passes by. The verifier entity 108 may provide proof of execution to the approver(s) 106. The proof of execution can be a zero-knowledge proof (ZKP) that hides the information about the actual workflow and approvals while providing the assurance that the workflow has been followed completely.

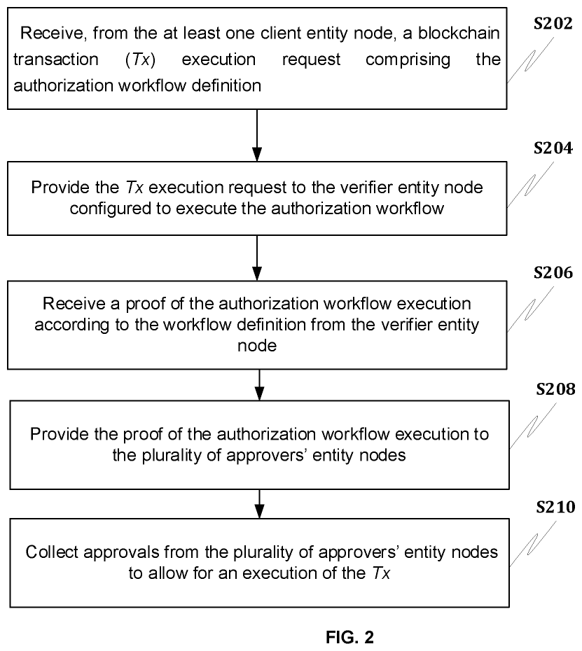

FIG. 2 illustrates an example flowchart of a method for validation of correct execution of workflow prior to execution of a blockchain transaction consistent with the disclosed embodiments.

At S202, the processor of the orchestrator node 104 (see FIG. 1) may receive, from at least one client entity node 101, a blockchain 110 transaction (Tx) execution request including the authorization workflow definition. The client entity node 101 is associated with the wallet owner, who may set up the workflow definition.

At S204, the processor of the orchestrator node 104 may provide the Tx execution request to the verifier entity node 108, which is configured to execute the authorization workflow pre-set by the client entity node 101.

At S206, the processor of the orchestrator node 104 may receive proof of the authorization workflow execution according to the workflow definition from the verifier entity node 108.

At S208, the processor of the orchestrator node 104 may provide proof of the authorization workflow execution to the plurality of approvers' entity nodes 106.

At S210, the processor of the orchestrator node 104 may collect approvals from the plurality of approvers' entity nodes 106 to allow for the execution of the Tx. The orchestrator may collect proper approvals in the form of cryptographic signatures by the relevant approvers (e.g., entities 106). Approvers may be presented with partial proof of the policy to show that their signature is required. Once all approvals are collected, the orchestrator creates proof of the correct execution, indicating that the policy has been run according to the latest predefined policy that the wallet is committed to. The proof is accompanied by or includes all the approvals as required by the workflow. If proper proof cannot be provided, the next steps are not executed, and the signature (or Tx) is aborted.

In one embodiment, a client of a client situation may be resolved. The verification process may be performed after the transaction has been executed—e.g., an audit can be made by anyone who has the commitment.

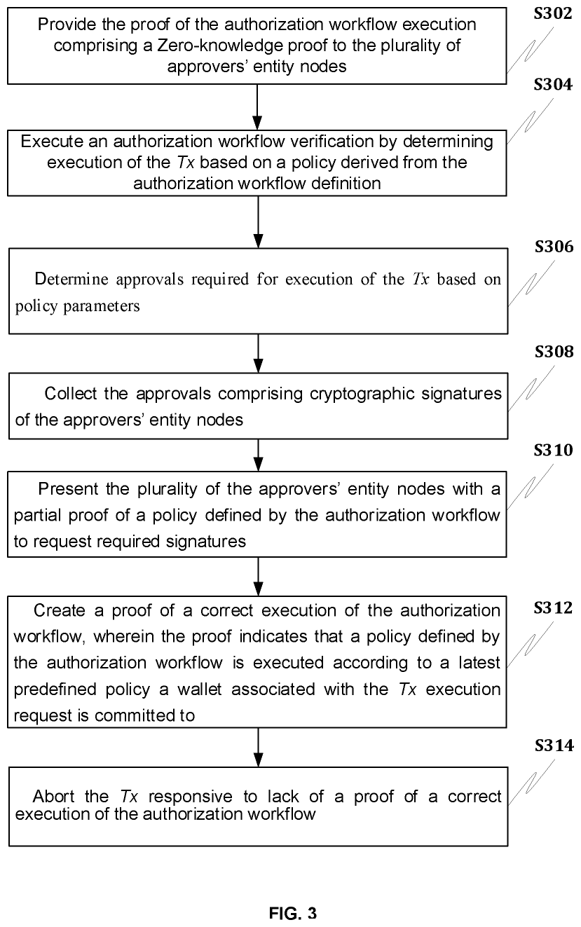

FIG. 3 illustrates a further example flowchart of a method for validation of correct execution of workflow prior to execution of a blockchain transaction consistent with the disclosed embodiments.

Referring to FIG. 3, at S302, the processor of the orchestrator node 104 may provide proof of the authorization workflow execution comprising a Zero-knowledge proof to the plurality of approvers' entity nodes. The verifier entity 108 may provide proof of execution to the approver(s) 106. The proof of execution may be a zero-knowledge proof (ZKP) that hides the information about the actual workflow (or workflow definition) and approvals while providing the assurance that the workflow has been followed completely with the correct outcome.

At S304, the processor of the orchestrator node 104 may execute an authorization workflow verification by determining the execution of the Tx based on a policy derived from the authorization workflow definition.

At S306, the processor of the orchestrator node 104 may determine approvals required for the execution of the Tx based on policy parameters. For example, a transaction below 1000$ may require one approval, while a transaction above 1000$ may require multiple approvers. A transaction on one blockchain may require less approvals than another blockchain, for example, if that blockchain is “testnet” (i.e., play money).

At S308, the processor of the orchestrator node 104 may collect the approvals comprising cryptographic signatures of the approvers' entity nodes.

At S310, the processor of the orchestrator node 104 may present the plurality of the approvers' entity nodes with partial proof of a policy defined by the authorization workflow to request required signatures.

At S312, the processor of the orchestrator node 104 may create a proof of a correct execution of the authorization workflow. The proof may be provided in a form of a hash value. In an embodiment, the proof indicates that a policy defined by the authorization workflow is executed according to the latest predefined policy a wallet associated with the Tx execution request is committed to. The verification of the approval for executing the transaction may be implemented in a secure enclave or an HSM or inside a smart contract, and so on.

At S314, the processor of the orchestrator node 104 may abort the Tx responsive to a lack of proof of correct execution of the authorization workflow. In other words, the Tx Is not committed to the blockchain unless it is properly approved.

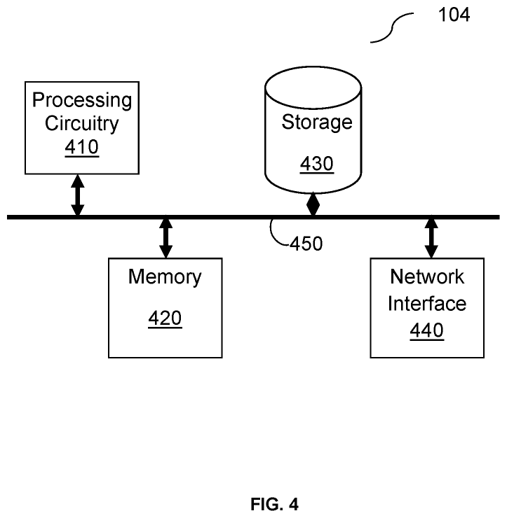

FIG. 4 is an example block diagram of a hardware layer depicting a node 104, according to an embodiment. The node 240 may be a compute node or a network node and includes a processing circuitry 410 coupled to a memory 420, a storage 430, and a network interface 440. In an embodiment, the components of the verification system may be communicatively connected via a bus 450.

The processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 420 may be volatile (e.g., random access memory, etc.), non-volatile (e.g., read-only memory, flash memory, etc.), or a combination thereof.

In one configuration, software for implementing one or more embodiments disclosed herein may be stored in storage 430. In another configuration, the memory 420 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 410, cause the processing circuitry 410 to perform the various processes described herein.

The storage 430 may be magnetic storage, optical storage, and the like, and may be realized, for example, as flash memory or another memory technology, compact disk-read only memory (CD-ROM), Digital Versatile Disks (DVDs), or any other medium which can be used to store the desired information.

The network interface 440 allows node 104/105 to communicate with the various components, devices, and systems described herein for production code static analysis, as well as other like purposes. The network interface 440 can be a port of the network node.

It should be understood that the embodiments described herein are not limited to the specific architecture illustrated in FIG. 4, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to and executed by a machine comprising any suitable architecture. Preferably, the machine is implemented on a computer platform having hardware such as one or more central processing units (“CPUs”), memory, and input/output interfaces. The computer platform may also include an operating system and microinstruction code. The various processes and functions described herein may be either part of the microinstruction code or part of the application program or any combination thereof, which may be executed by a CPU, whether or not such a computer or processor is explicitly shown. In addition, various other peripheral units may be connected to the computer platform, such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A system for validation of a correct execution of an authorization workflow, comprising:
a processor of an orchestrator node connected to at least one client entity node, a verifier entity node and to a plurality of approvers' entity nodes; and
a memory on which are stored machine-readable instructions that when executed by the processor, cause the processor to:
receive, from the at least one client entity node, a blockchain transaction (Tx) execution request comprising the authorization workflow definition;
provide the Tx execution request to the verifier entity node configured to execute the authorization workflow;
receive a proof of the authorization workflow execution according to the workflow definition from the verifier entity node;
provide the proof of the authorization workflow execution to the plurality of approvers' entity nodes; and
collect approvals from the plurality of approvers' entity nodes to allow for an execution of the Tx.

2. The system of claim 1, further comprising machine-readable instructions that when executed by the processor, cause the processor to:
provide the proof of the authorization workflow execution comprising a Zero-knowledge proof to the plurality of approvers' entity nodes.

3. The system of claim 1, further comprising machine-readable instructions that when executed by the processor, cause the processor to:
execute an authorization workflow verification by determining execution of the Tx based on a policy derived from the authorization workflow definition.

4. The system of claim 1, further comprising machine-readable instructions that when executed by the processor, cause the processor to:
determine approvals required for execution of the Tx based on policy parameters.

5. The system of claim 1, further comprising machine-readable instructions that when executed by the processor, cause the processor to:
collect the approvals comprising cryptographic signatures of the approvers' entity nodes.

6. The system of claim 1, further comprising machine-readable instructions that when executed by the processor, cause the processor to:
present the plurality of the approvers' entity nodes with a partial proof of a policy defined by the authorization workflow to request required signatures.

7. The system of claim 1, further comprising machine-readable instructions that when executed by the processor, cause the processor to:
create a proof of a correct execution of the authorization workflow, wherein the proof indicates that a policy defined by the authorization workflow is executed according to a latest predefined policy a wallet associated with the Tx execution request is committed to.

8. The system of claim 1, wherein the proof of the authorization workflow execution comprises all approvals as required by the workflow definition.

9. The system of claim 1, further comprising machine-readable instructions that when executed by the processor, cause the processor to:
abort the Tx responsive to lack of a proof of a correct execution of the authorization workflow.

10. A method for validation of a correct execution of an authorization workflow, comprising:
receiving, by an orchestrator node, from at least one client entity node, a blockchain transaction (Tx) execution request comprising an authorization workflow definition;
providing, by the orchestrator node, the Tx execution request to a verifier entity node configured to execute the authorization workflow;
receiving, by the orchestrator node, a proof of the authorization workflow execution according to the workflow definition from the verifier entity node;
providing, by the orchestrator node, the proof of the authorization workflow execution to a plurality of approvers' entity nodes; and
collecting, by the orchestrator node, approvals from the plurality of approvers' entity nodes to allow for an execution of the Tx.

11. The method of claim 10, further comprising:
providing the proof of the authorization workflow execution comprising a Zero-knowledge proof to the plurality of approvers' entity nodes.

12. The method of claim 10, further comprising:
executing an authorization workflow verification by determining execution of the Tx based on a policy derived from the authorization workflow definition.

13. The method of claim 12, further comprising:
determining approvals required for execution of the Tx based on policy parameters.

14. The method of claim 10, further comprising:
collecting the approvals comprising cryptographic signatures of the approvers' entity nodes.

15. The method of claim 10, further comprising:
presenting the plurality of the approvers' entity nodes with a partial proof of a policy defined by the authorization workflow to request required signatures.

16. The method of claim 10, further comprising creating a proof of a correct execution of the authorization workflow, wherein the proof indicates that a policy defined by the authorization workflow is executed according to a latest predefined policy a wallet associated with the Tx execution request is committed to.

17. The method of claim 10, wherein the proof of the authorization workflow execution comprises all approvals as required by the workflow definition.

18. A non-transitory computer-readable medium having stored thereon instructions for causing a processing circuitry to execute a process, the process comprising:
Receiving from at least one client entity node, a blockchain transaction (Tx) execution request comprising an authorization workflow definition;
providing the Tx execution request to a verifier entity node configured to execute the authorization workflow;
receiving a proof of the authorization workflow execution according to the workflow definition from the verifier entity node;
providing the proof of the authorization workflow execution to a plurality of approvers' entity nodes; and
collecting approvals from the plurality of approvers' entity nodes to allow for an execution of the Tx.

19. The non-transitory computer-readable medium of claim 18 having stored thereon instructions for causing a processing circuitry to execute a process, the process comprising providing the proof of the authorization workflow execution comprising a Zero-knowledge proof to the plurality of approvers' entity nodes.

20. The non-transitory computer-readable medium of claim 19 having stored thereon instructions for causing a processing circuitry to execute a process, the process comprising creating a proof of a correct execution of the authorization workflow, wherein the proof indicates that a policy defined by the authorization workflow is executed according to a latest predefined policy a wallet associated with the Tx execution request is committed to.
